(19) United States
(12) Patent Application Publication
(10) Pub. No.: US 2021/0018363 A1
(43) Pub. Date: Jan. 21, 2021

(54) SYSTEM AND METHOD FOR LOW NOISE ELECTROMAGNETIC RADIATION MEASUREMENT ENABLING TO MEASURE WEAK SIGNALS

(71) Applicant: Universidad de Chile, Santiago (CL)

(72) Inventors: Felipe Ernesto Besser Pimentel, Las Condes (CL); Ernest Alexander Michael, Santiago (CL)

(21) Appl. No.: 16/511,206

(22) Filed: Jul. 15, 2019

(51) Int. Cl. G01J 1/44; G01T 1/24

(52) U.S. Cl. CPC G01J 1/44; G01J 2001/4413; G01T 1/24

(57) ABSTRACT

A system and method for low noise electromagnetic radiation measurement enabling to measure weak signals is provided. The electromagnetic radiation measurement system is configured for detecting weak electromagnetic radiation input signals overcoming the quantum limit. The electromagnetic radiation|measurement system includes at least one or more first 50/50 power splitter receiving the input signal; two or more identical balanced heterodyne receivers; two or more LNAs; one or more local oscillator (LO), one or more optical isolator; one or more second 50/50 power splitter; a digital correlator; and a computer or a similar computational device.

### FIELD OF THE INVENTION

The invention relates generally to the field of electromagnetic radiation measurement and more particularly to a system and method to improve the sensibility of receivers to detect weak signals. For instance, in astronomical applications where the ultimate aim is to detect weaker signals over affordable integration times.

The solution by the invention is based on a balanced photodiode architecture, which eliminates excess noise, and consequently improves the level of detection, thanks to the effects of the cross-correlation sensitivity between two identical balanced heterodyne receivers, which allow to overcome the theoretical limit established by quantum mechanics.

In the current state of the art, similar alternative solutions exist, but they are affected by the quantum fundamental limit, and therefore they have lower detection sensitivity.

### BACKGROUND OF THE INVENTION

The sensitivity of electromagnetic radiation receivers is mainly affected by vacuum fluctuations of the electromagnetic field and inherent limitations of quantum statistics. Two radiation detection principles compete here to achieve the higher signal-to-noise ratio (SNR): direct and heterodyne detection.

In direct (incoherent) detection the signal photons alone generate directly photoelectrons. The sensitivity is then limited only by the counting noise of the signal photons detected from a thermal source in a measurement time interval, but substantial post-detection amplifier noise adds to this. High spectral resolution is achievable only with bulky wavelength-dispersive optics in front of detector arrays, which is increasingly lossy towards higher resolutions.

In heterodyne (coherent) detection, the electromagnetic field to be detected is mixed on a fast detector (the mixer) with a strong monochromatic reference signal, the “local oscillator” (LO), down-converting the sidebands into the intermediate frequency (IF) band, preserving their phases. Therefore, the signal can be amplified in the very moment of detection so highly, by multiplication with the strong LO, that the impact of post-mixer IF-amplifier noise is eliminated. Unfortunately, this brings in fundamental quantum noise from the vacuum fluctuations. Such can be formally regarded as emitted by a thermal source of “noise temperature”.

It seems to be not understood yet why direct detection should not see the noise of the vacuum fluctuations, and on the other hand, why then it does not exist a heterodyne receiver configuration which avoids these vacuum fluctuations. Whatever their nature is, it is a challenge to find out how to bypass them in heterodyne detection. In particular, considering that the maximum possible sensitivity of heterodyne detection in cross-correlation between two receivers has been tacitly assumed so far to be as well determined by the quantum limit.

In the prior art it is possible to find a large number of related documents in the field of optical detectors/receivers, mostly aimed at optimizing the sensitivity at the reception of signals, and consequently the signal to noise ratio of the devices. The proposed solutions to the problems presented by the existing devices are proposed in different ways, such as variations in the power and noise present in the local oscillator, fluctuations in the polarization of the optical fiber, and noise associated with the quantum detection process (quantum limit). Nevertheless, none of them disclose an approach that considers a configuration with two balanced heterodyne receivers, in such a way that thanks to the effects of a cross-correlation, it results in allowing the breaking of the quantum limit barrier.

On one hand, it is possible to find some scientific documents analyzing the performance of a dual-detector optical heterodyne receiver and explaining in detail the advantages offered by the suppression of noise. For example: “A dual-detector optical heterodyne receiver for local oscillator noise suppression”, by Abbas, Chan et al. (J. Lightw. Technol., vol. LT-3, no. 5, pp. 1110-1122, 1985), then it is considered that this type of receiver is known in the state of the art. FIG. 1 is a block diagram depiction of a prior art balanced heterodyne receiver for fiber optics.

Regarding the quantum limit, there is technical literature analyzing quantum optical theory, in particular the technologies used in the local oscillator and associated with “entanglement” and the so-called “squeezed states of light” or simply “squeezed light”. For example in Jaekel and Reynaud, “Quantum limits in interferometric measurements”. (Europhysics Letters 13: 301-306, 1990). There are also some patent documents (for example CN20161995645) that propose alternatives that exceed this limit using these techniques. However, in all of these cases, the effect of overcoming the quantum limit is related to the cited techniques, that is to say “entanglement” and/or “squeezed light”, and not as a result of a cross-correlation given a configuration of two balanced receivers as proposed in this invention.

Additionally, there is ample literature describing correlation receivers with the typical intention to suppress the uncorrelated thermal noise and amplifier gain fluctuations of the two parallel receivers, e.g. as disclosed in Staggs, Jarosik et al., “An absolute measurement of the cosmic microwave background radiation temperature at 20 centimeters” (The Astrophysical. Journal, 458:407-418, 1996). Surprisingly, seemingly none of them considers LOs with uncorrelated noise, because all of them assume a single LO simply split up to feed both receiver chains.

In the present invention, it is exactly covered this case of uncorrelated LO noise on both receivers and it is demonstrated experimentally, that the sensitivities of “traditional” balanced receivers and correlation receivers, both operating already near to the quantum limit, can be further improved substantially by combining both concepts into a so-called “balanced correlation receiver”, which according to the experimental results is capable of breaking the quantum limit. In fact, it was measured about an order of magnitude increase of sensitivity (lower noise temperature) in cross-correlation compared to auto-correlation (single receiver).

Applications for a receiver operating below the quantum limit could be ubiquitous: for laser interferometers in gravitational wave astronomy, for imaging technologies in medicine (e.g. optical coherence tomography) or in the life sciences (e.g. fluorescence microscopy). In particular, this application is especially relevant in imaging astronomical interferometry, where the highest possible visibility sensitivities are required to extend telescope baselines to the utmost. Also, the system described herein ca be employed—in any field of interest—for the measurement of any electromagnetic radiation, including radio waves, microwaves, infrared, light, visible light, ultraviolet, X-rays and gamma rays.

### SUMMARY OF THE INVENTION

A system and method for low noise electromagnetic radiation measurement, which enhance the sensitivity and therefore enable to measure weak signals. The invention is related to the problem existing in the optical detection of improving the receiver sensitivity in order to detect weak signals, for example in astronomical applications. In this type of receivers, sensitivity is affected by fluctuations of the magnetic field and by inherent limitations of quantum mechanics.

The proposed solution, based on a balanced photodiode architecture, eliminates “excess noise”, and consequently improves the level of detection, thanks to the effects of cross-correlation sensitivity between two identical balanced heterodyne receivers, which allow to exceed the theoretical limit established by quantum mechanics.

In the current state of the art, similar alternative solutions exist, but they are affected by the quantum fundamental limit, and therefore have lower detection sensitivity.

The proposed invention has special application in astronomy, where the ultimate aim is to detect weakest signals over affordable integration times. However, the application scope of the invention is not limited to astronomy, but it also includes other fields, such telecommunications, medical imaging, mining, and in general systems where electromagnetic radiation transmission is used.

These and other aspects of the present invention, and its advantages will become apparent from the detailed description, specifications and appended claims, taken in conjunction with the accompanying drawings, illustrating by way of examples the principles of the invention.

### BRIEF DESCRIPTION OF THE DRAWINGS

FIG. 1 is a block diagram depiction of a prior art balanced heterodyne receiver for fiber optics.

FIG. 2 is a block diagram showing a preferred configuration of the system according to the present invention.

FIG. 3 depicts one preferred embodiment of the system according to the present invention.

FIG. 4 shows a plot of the receiver noise temperature measurement associated to the system described with reference to FIG. 3. The plot depicts the mean power per channel as function of total SLED power (input signal).

FIG. 5 (a) shows Allan-plots of the variance as a function of the integration time for the auto-correlation of receiver A (B very similar).

FIG. 5 (b) shows Allan-plots of the variance as a function of the integration time the cross correlation between both receivers, associated to the system described with reference to FIG. 3.

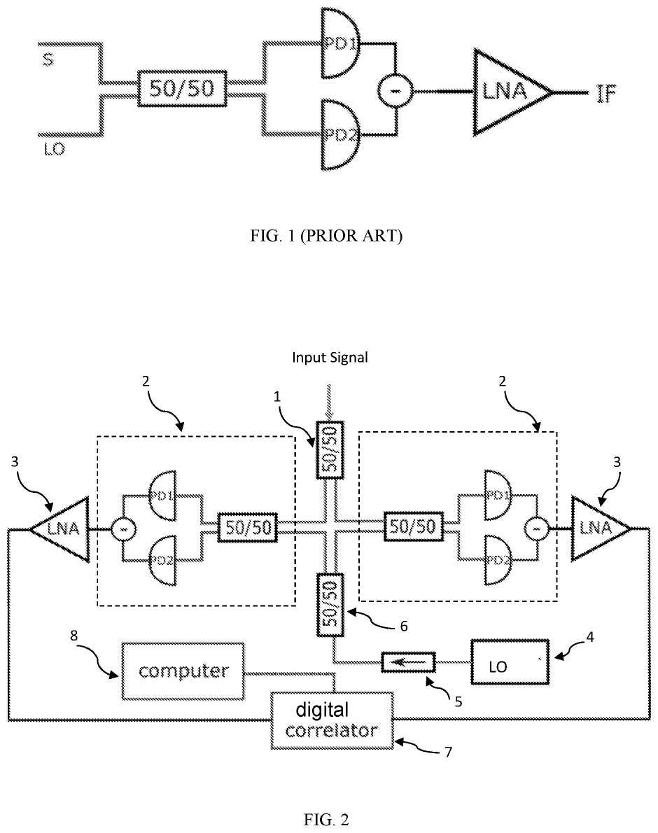

### DETAILED DESCRIPTION OF THE INVENTION

It is an object of the invention to provide a system and method for low noise electromagnetic radiation measurement enabling to measure weak signals. The objects are solved by the independent claims and further embodiments are shown by the dependent claims.

According to the present invention, the electromagnetic radiation measurement system is configured for detecting weak electromagnetic radiation input signals overcoming the quantum limit. One preferable configuration of the system is explained in reference of FIG. 2, which shows a basic configuration of the system according to the present invention.

The electromagnetic radiation|measurement system includes at least one or more first 50/50 power splitter (1) receiving the input signal; two or more identical balanced heterodyne receivers (2); two or more LNAs (3); one or more local oscillator (LO) (4), one or more optical isolator (5); one or more second 50/50 power splitter (6); a digital correlator (7); and a computer or a similar computational device (8).

The electromagnetic radiation measurement system and method involve an operation such that the received input signal is splitted up equally using the one or more first 50/50 power splitter (1), then, the two or more generated signals are injected to each of the two or more heterodyne receivers (2), each of them having dual detectors arranged in a balance photodiode (PD) configuration,

On the other hand, a power signal providing from the one or more local oscillator, LO (4) is (optionally) directed to one or more electromagnetic radiation isolator (5) to prevent standing waves due to back-reflections, previously to be directed to one or more second 50/50 fiber power splitter (6), which distributes the LO power equally as another input to two of more heterodyne receivers (2). The heterodyne receivers are disposed in a cross-correlation arrangement.

After that, the IF output signals existing in each heterodyne receiver, after the balanced PDs, are amplified using one or more LNA (3) located at each output respectively. This configuration is complemented generally, including an attenuator in between the LNAs to prevent saturation and other one or more attenuator after them (not included in FIG. 2). Subsequently, the signals are fed to a digital correlator (7), where the signals are digitized and correlated, usually but not limited, using an FPGA chip (“Field-Programmable Gate Array”). Finally the signal is processed in a computer or a similar computational device (8).

The system configuration shown in the present invention (unlike prior art) considers the case of uncorrelated LO noise on two or more receivers and allows to demonstrate that the sensitivities of “traditional” balanced receivers and correlation receivers, both operating already near to the quantum limit, can be further improved substantially by combining both concepts into a so-called “balanced correlation receiver”, which according to experimental results it is capable of breaking the quantum limit.

In this way, the arrangement provided by the invention, including two or more heterodyne balanced receivers (four detectors) in cross-correlation, gives the possibility to measure weaker signals than using a single balanced receiver (two or more detectors). In fact, with the embodiment disclosed above, it was possible to increase the sensitivity about an order of magnitude (lower noise temperature) in cross-correlation compared to auto-correlation (single receiver).

In order to explain how balanced receivers reach quantum limited sensitivity, it would be considered that any laser excess noise inclusive underlying shot noise is cancelled by the output subtraction after each balanced photodiode. Then, both balanced photodiode's power splitters create new laser shot noise through partition noise which is not cancelled. Such is locally and spontaneously created at each power splitter and therefore uncorrelated between both balanced receivers. This fact is exploited to create a cross-correlation of the laser noise from both balanced receivers a factor of up to 20 smaller than obtained in auto-correlation for each receiver alone, even amplifying the signal much less than the optimum calculated. Therefore, with the slope of IF output versus optical signal input maintained from auto-correlation, it results a noise temperature factor of up to 20 less.

The semi-classical photon deletion theory can be used to show that the post-detection laser shot noise contributions on both the receivers must be completely uncorrelated in this case of passing three power splitters.

Regarding this theory and considering the setup proposed by the invention, it can be noted that the LO is represented by a single laser whose excess noise signals must be common-mode after the one or more first distribution power splitter. Therefore, balanced photodiodes with the related 50/50-power splitters in front are necessary in order to replace the laser noise in each of the two or more receivers by the power-splitter partition noise, which is undistinguishable from shot noise and completely uncorrelated to the original laser noise, so that the propagated laser noise at both receivers would be uncorrelated.

The crucial assumption of the invention is that it can be achieved in principle, a laser correlation coefficient tending to zero. For this, it is exploited that the normalized Gaussian random noise phasor, generated at a power splitter A in a balanced photodiode assembly A is statistically independent from that generated at a second power splitter B in another balanced photodiode assembly B.

To derive this, it is considered the mentioned semi-classical particle deletion model in the following: when a light signal is propagated it is either attenuated, split, or amplified. The question is what happens in these cases with the imprinted noise starting with the signal. In the case of the invention, with the distribution of the LO laser signal, all these signal parts are finally detected by the different detectors (the heterodyne mixers). In that case an individual LO photon is finally detected only at one of these mixers, and so has to behave at the intermediate power splitters like a particle which is either transmitted or reflected, but not both at the same time which would be the behavior of a wave-like signal. This means that with the detection (absorption) at a particular detector, it is destroyed all the other possible states of the overall probability amplitude wave function.

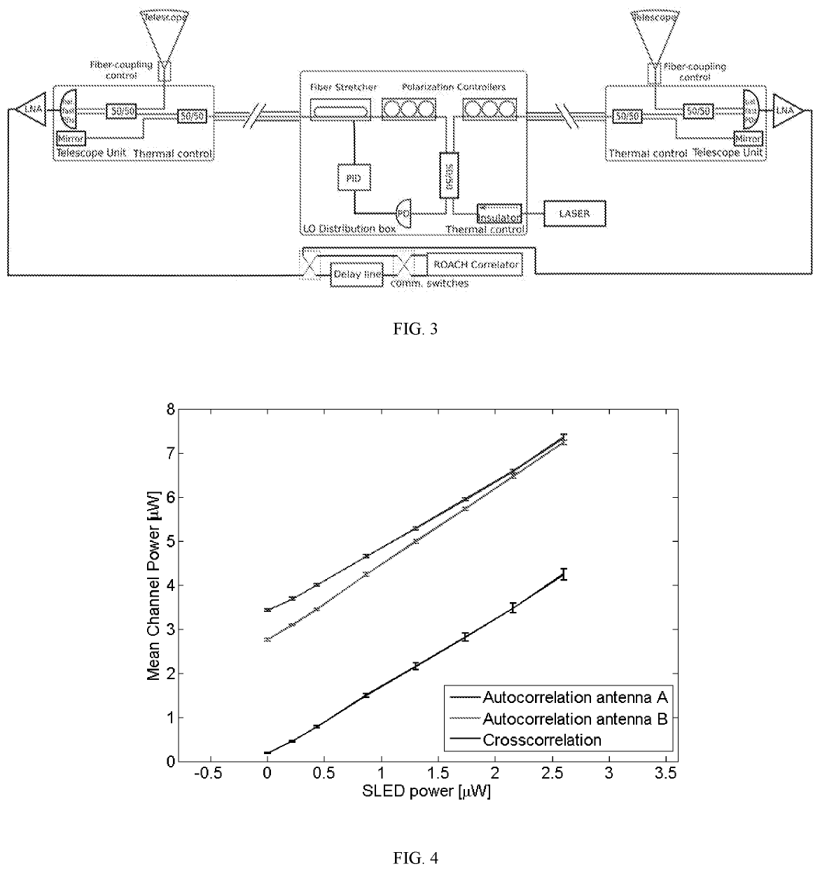

As one example of application, FIG. 3 shows a preferred embodiment of the invention. In this embodiment the optical system is depicted comprising two fiber-optic circuit units: the Local Oscillator (LO) distribution box (LODB, at the bottom center) and the receiver boxes (RB, at the center). Additionally, in this embodiment the digital correlator is a device which is programmed onto a Reconfigurable Open Architecture Computer Hardware (ROACH1) platform.

In this embodiment, a fixed frequency fiber laser, a Koheras Adjustik (NKT Photonics) is used as a local oscillator (LO), working at 1556 nm with 1 kHz of linewidth and a thermal fine tuning capability of ±0.5 nm. Attenuated to a power or 3 mW the laser has a Fano factor of about 10. The LODB contains an insulator at the LO input, to prevent standing waves due to back-reflections. A 50/50 fiber splitter distributes the laser power equally towards both receivers (in fact a tunable one to fine-adjust equal pump power to both balanced receivers to better than 5%) and redirects the fiber mirror reflections from there towards a slow photodiode (PD), on which interference fringes are formed (fiber-based Michelson interferometer). The PID control loop stabilizes the photodiode signal on the edge of one of these interference fringes by changing the fiber length in one of both arms with a fiber stretcher.

In the RB circuits a fiber splitter directs 50% of the laser power towards the mentioned fiber mirror, and the other 50% through an insulator, avoiding here any standing wave interaction between both balanced photodiode receivers assemblies. Those contain tunable fiber splitters in order to balance both photodiodes of each receiver to better than 5%.

The balanced photodiode assemblies (Newport 1617-AC-FC) have a common-mode rejection of 25 dB, a 3 dB-roll-off frequency of 800 MHz, and include a transimpedance amplifier of 11.5 dB gain (1 A/W to 700V/W for 50Ω). After the balanced PDs, the IF signals are amplified by another 40-45 dB. This task is performed by two LNAs of 35 dB gain and 1.4 dB NF, 0.02-3 GHz BW, with a 20 dB attenuator in between both to prevent saturation in the second and a 10 dB (later 5 dB) attenuator after them, before they are fed to the analog to digital converters (ADC) of the ROACH correlator.

The correlator is a ROACH1-board assembly (Reconfigurable Open Access Computing Hardware), containing a Xilinx FPGA, to which are attached two 8 bit-iADCs of 3GS/s. The instrument was conceptualized and developed by the CASPER Group at Berkeley and fabricated by Digicom Electronics, Inc. For this embodiment, the correlator model run on a model developed for a bandwidth of 800 MHz from the FX pocket correlator model available from the CASPER group. In order to reduce drifts from thermal instabilities, the model can be extended with a Dicke-switch for on/off-measurements as known from radio astronomy.

In order to verify experimentally the solution proposed by the invention, the noise temperatures of the two balanced receivers included in the embodiment described above (see FIG. 3) were measured, using a response plot over various source powers. This included the careful calibration of the spectral power densities of three different sources (a fiber-coupled SLED, a halogen lamp, and the fiber-frequency shifted LO itself).

In this way, it was measured the auto- and cross-correlation outputs as a function of the weak signal power (system noise temperature measurement) and it was obtained a cross-correlation system noise temperature up to 20 times lower than for the auto-correlation system noise temperature of each receiver separately. The receiver noise temperature results using the SLED source are shown in FIG. 4.

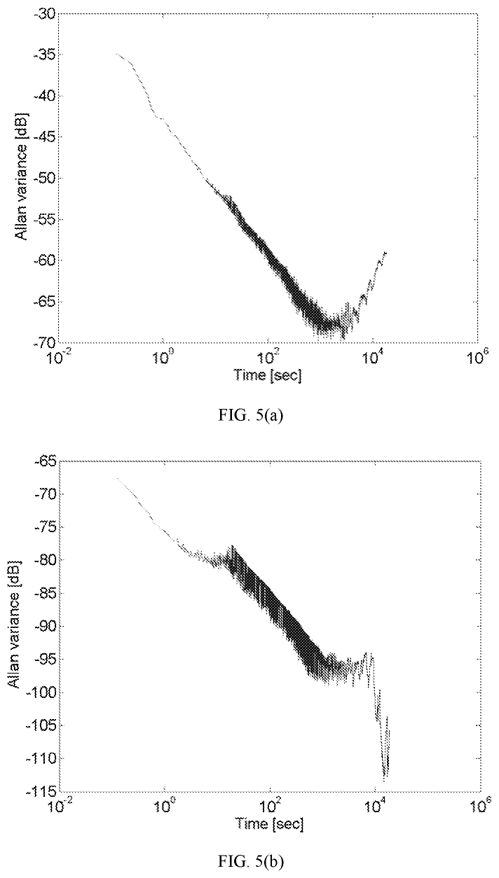

The conclusion is then that in cross-correlation the sensitivity reaches already clearly below the single-receiver quantum limit. These results are also supported by Allan plot measurements showing cross-correlation standard deviations 30 times lower than in auto-correlation. In FIG. 5 are shown the Allan plots of the variance as a function of the integration time, of a) the auto-correlation of receiver A (B very similar), and b) the cross correlation between both receivers at 400 nW total halogen lamp power coupled into the single-mode fiber. The time series of the data recorded for these plots was about 10 hours.

The depth below the shot-noise limit measured here (5-6 dB) was larger than it was demonstrated previously with a photon number squeezed local oscillator in a single receiver, (2-3 dB), as it is disclosed for example in the document “Sub-shot-noise-limited optical heterodyne detection using an amplitude-squeezed local oscillator,” by Li, Y.-Q, Guzun, D. and Xiao, M., 1999 (Phys. Rev. Lett., vol. 82, p. 5225).

Modifications within the scope of this invention can be made by any person ordinary skilled in the art without departing from the spirit thereof. Therefore, the invention must be defined by the scope of the appended claims as broadly as the prior art will permit, and in view of the specifications if necessary.

1. A system for low noise electromagnetic radiation measurement enabling to measure weak signals, the system comprising:
one or more first 50/50 power splitter configured for receiving an input signal and for splitting it up equally generating two or more output signals, each of these signals being subsequently derived as an input to each of two or more heterodyne receivers;
one or more local oscillator (LO) source configured for generating an electromagnetic radiation local oscillator signal;
one or more second 50/50 power splitter, connected to the output of the LO, to distribute the LO power equally as an input to each of two heterodyne receivers;
two or more identical optical heterodyne receivers, each of them having dual detectors arranged in a balance photodiode configuration, and each of them disposed to receive as an input one of the splitted signals coming from the first power splitter and as another input one of the LO power splitted signals coming from the one or more second power splitter, being the heterodyne receivers disposed in a cross-correlation arrangement;
two or more Low Noise Amplifiers (LNAs), disposed at the IF output of each heterodyne receiver and configured to amplify said IF signals;
a digital correlator, for receiving the signals coming from the LNAs and configured to digitized and correlated said signals; and
computational means to processing the signal coming from the digital correlator.

2. The system according to claim 1, further comprising one or more electromagnetic radiation isolator, connected to the output of the one or more LO, to prevent standing waves due to back-reflections.

3. The system according to claim 1, wherein the second 50/50 fiber splitter connected to one or more LO, is a tunable fiber splitter, to fine-adjust equal pump power to the balanced receivers to better than 5%.

4. The system according to claim 1, further comprising one or more attenuator in between the LNAs and after them, to prevent saturation.

5. The system according to claim 1, wherein the digital correlator is a Field-Programmable Gate Array (FPGA) chip.

6. The system according to claim 1, further comprising one or more slow photodiode (PD) for receiving the fiber mirror reflections from the one or more second power splitter located after the one or more LO, where interference fringes are formed.

7. The system according to claim 6, further comprising a proportional-integral-derivative (PID) control loop and a fiber stretcher, said PID controller disposed to stabilize the signal coming from said slow PD, on the edge of one of said interference fringes, through changing the fiber length in one of both arms using said fiber stretcher.

8. The system according to claim 1, wherein said electromagnetic radiation is selected from the group consisting of radio waves, microwaves, infrared, light, visible light, ultraviolet, X-rays, and gamma rays.

9. A method for low noise electromagnetic radiation measurement enabling to measure weak signals, the method comprising the steps of:
providing an input signal;
splitting up the input signal equally using one or more first 50/50 power splitter generating two or more output signals;
deriving said splitted signal as an input to each of two or more heterodyne receivers;
providing one or more local oscillator (LO) power signal;
distributing the LO power equally as an input to two or more heterodyne receivers, using one or more second 50/50 power splitter;
arranging each of two or more identical heterodyne receivers in a balance photodiode configuration;
receiving by each of said two or more heterodyne receivers, the splitted input signal coming from one or more first power splitter as a first input and the equal portion of the LO power signal as a second input, being the said heterodyne receivers disposed in a cross-correlation arrangement;
amplifying the IF signal being at the output of each of said two or more heterodyne receivers using one or more LNA in each receiver respectively;
digitizing and correlating the signal coming from the LNAs in a digital correlator; and
processing the signal coming from the correlator using computational means.

10. The method according to claim 9, further comprising the step of:
electromagnetic radiation isolating of the output of the one or more LO, to prevent standing waves due to back-reflections.

11. The method according to claim 9, wherein said step of distributing the LO power is performed using one or more tunable fiber splitter, to fine adjust equal pump power to both balanced receivers to better than 5%.

12. The method according to claim 9, further comprising the step of:
attenuating the signal in between the LNAs and after them, to prevent saturation.

13. The method according to any of the claim 9, wherein the said step of digitizing and correlating the signal, is performed/realized using a Field-Programmable Gate Array (FPGA) chip.

14. The method according to claim 9, further comprising the step of:
receiving by one or more slow photodiode (PD), the fiber mirror reflections from the one or more second power splitter located after the one or more LO, where interference fringes are formed;

15. The method according to claim 14, further comprising step of:
stabilizing the signal coming from said slow PD, by a proportional-integral-derivative (PID) control loop, by changing the fiber length in one of both arms using a fiber stretcher, said PID controller disposed on the edge of one of said interference fringes.

16. The method according to claim 9, wherein said electromagnetic radiation is selected from the group consisting of radio waves, microwaves, infrared, light, visible light, ultraviolet, X-rays, and gamma rays.
